(19) United States
(12) Patent Application Publication
(10) Pub. No.: US 2019/0100202 A1
(43) Pub. Date: Apr. 4, 2019

(54) DRIVING SUPPORT SYSTEM, DRIVING CONTROL SYSTEM, ROUTE GUIDE SYSTEM, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Xin JIN, Nagoya-shi (JP); Hironobu SUGIMOTO, Nagoya-shi (JP); Hiroaki SAKAKIBARA, Nagoya-shi (JP); Shingo KINASHI, Okazaki-shi (JP); Kazuteru MAEKAWA, Miyoshi-shi (JP); Sadahiro KOSHIBA, Takahama-shi (JP); Takahiro YAMAGUCHI, Okazaki-shi (JP); Yuji SATO, Owariasahi-shi (JP); Seiji TAKAHATA, Nishio-shi (JP)

(73) Assignee: TOYOTA JIDOSHA KABUSHIKI KAISHA, Toyota-shi (JP)

(21) Appl. No.: 16/047,194

(22) Filed: Jul. 27, 2018

(30) Foreign Application Priority Data
Sep. 29, 2017 (JP) 2017-190618

(51) Int. Cl. B60W 30/182; G05D 1/02; G01C 21/34

(52) U.S. Cl. CPC B60W 30/182; G05D 1/0212; B60W 2550/14; G05D 2201/0213; G01C 21/3415

(57) ABSTRACT

Provided is a technique for reducing a possibility that a route guide and driving control are respectively performed on roads which are not consistent with each other. A driving support system includes a route guide portion that specifies a traveling road for guide that is a road on which a vehicle is traveling, and that performs a route guide based on the traveling road for guide. The driving support system also includes a driving control portion that specifies a traveling road for control that is the road on which the vehicle is traveling, and that performs driving control based on the traveling road for control. The driving support system also includes a cancel control portion that cancels at least one of the route guide and the driving control when the traveling road for guide and the traveling road for control are not consistent with each other.

### BACKGROUND

### 1. Technical Field

The present invention relates to a driving support system, a driving control system, a route guide system, and a non-transitory computer readable storage medium storing a driving support program.

### 2. Related Art

A map data processing device which uses a map database for a route guide and a high-precise map database for driving support control including automatic driving has been known (refer to JP 2016-161456 A).

According to the device disclosed in JP 2016-161456 A, it is necessary to specify a road on which a vehicle is currently traveling, in order to perform the route guide and the driving support control. In the device disclosed in JP 2016-161456 A, since the map database for the route guide and the map database for the driving support control are different from each other, decision results respectively specifying the roads on which the vehicle is currently traveling sometimes are not consistent with each other. In this case, because the road on which the route guide is performed and the road on which the driving support is performed are not consistent with each other, a driver falls into confusion and so on.

### SUMMARY

The present invention has been devised in view of the problem described above. The present invention provides a technique for reducing a possibility that a route guide and driving control are respectively performed on roads which are not consistent with each other.

The present invention provides a driving support system. The driving support system includes a route guide portion configured to specify a traveling road for guide that is a road on which a vehicle is traveling, and to perform a route guide based on the traveling road for guide. The driving support system also includes a driving control portion configured to specify a traveling road for control that is the road on which the vehicle is traveling, and to perform driving control based on the traveling road for control. The driving support system also includes a cancel control portion configured to cancel at least one of the route guide and the driving control when the traveling road for guide and the traveling road for control are not consistent with each other.

The present invention provides non-transitory computer readable storage medium storing a driving support program that, when executed by a computer, causes the computer to function as a route guide portion configured to specify a traveling road for guide that is a road on which a vehicle is traveling, and to perform a route guide based on the traveling road for guide. The driving support program also causes the computer to function as a driving control portion configured to specify a traveling road for control that is the road on which the vehicle is traveling, and to perform driving control based on the traveling road for control. The driving support program also causes the computer to function as a cancel control portion configured to cancel at least one of the route guide and the driving control when the traveling road for guide and the traveling road for control are not consistent with each other.

The present invention provides a driving control system for communicating with a route guide system configured to specify a traveling road for guide that is a road on which a vehicle is traveling, and to perform a route guide based on the traveling road for guide. The driving control system includes a driving control portion configured to specify a traveling road for control that is the road on which the vehicle is traveling, and to perform driving control based on the traveling road for control. The driving control system also includes a cancel control portion configured to cancel at least one of the route guide and the driving control when the traveling road for guide and the traveling road for control are not consistent with each other.

The present invention provides a route guide system. The route guide system includes a route guide portion configured to specify a traveling road for guide that is a road on which a vehicle is traveling, and to perform a route guide based on the traveling road for guide. The route guide system also includes a communication portion configured to communicate with a driving control system that specifies a traveling road for control that is the road on which the vehicle is traveling, and that performs driving control based on the traveling road for control. The route guide system also includes a cancel control portion configured to cancel at least one of the route guide and the driving control when the traveling road for guide and the traveling road for control are not consistent with each other.

### BRIEF DESCRIPTION OF DRAWINGS

FIG. 1 is a block diagram showing a driving support system.

FIG. 2 is a flowchart showing driving control processing.

FIG. 3 is a flowchart showing driving control processing according to a second embodiment.

### DETAILED DESCRIPTION

According to the above configuration, when the traveling road for guide that is specified by the route guide portion and the traveling road for control that is specified by the driving control portion are not consistent with each other, a possibility that the route guide and the driving control are respectively performed on the roads that are not consistent with each other is reduced by cancelling at least one of the route guide and the driving control. Incidentally, although each of the traveling road for guide and the traveling road for control is specified as the road on which the vehicle is traveling, both are sometimes inconsistent with each other because the route guide portion and the driving control portion respectively specify the roads.

As described above, according to the driving control system and the route guide system, at least one of the route guide and the driving control is cancelled when the traveling road for guide and the traveling road for control are not consistent with each other. Therefore, the possibility that the route guide and the driving control are respectively performed on the roads which are not consistent with each other is reduced.

According to the following order, embodiments of the present invention will be described hereinafter.

### (1) CONFIGURATION OF DRIVING SUPPORT SYSTEM:

### (1-1) CONFIGURATION OF VEHICLE:

### (1-2) CONFIGURATION OF ROUTE GUIDE SYSTEM:

### (1-3) CONFIGURATION OF DRIVING CONTROL SYSTEM:

### (2) DRIVING CONTROL PROCESSING:

### (3) SECOND EMBODIMENT:

### (4) OTHER EMBODIMENTS:

### (1) Configuration of Driving Support System

### (1-1) Configuration of Vehicle:

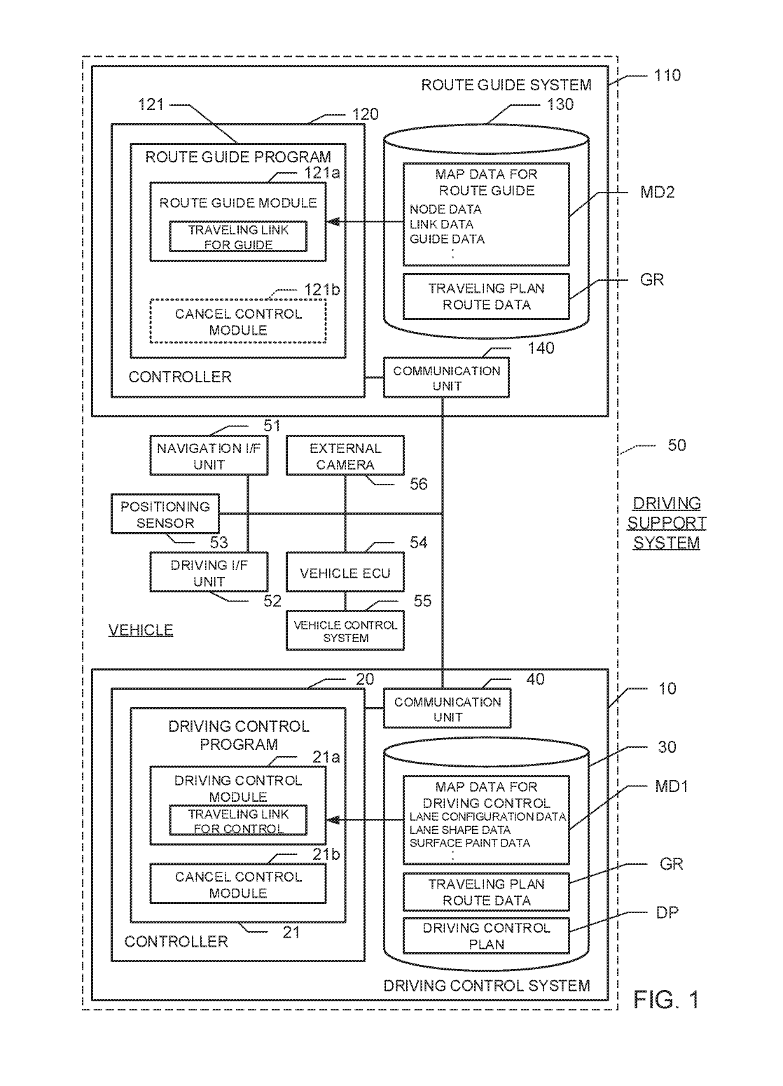

FIG. 1 is a block diagram showing a driving support system. A driving support system includes a driving control system 10 and a route guide system 110. A vehicle 50 is equipped with the driving control system 10 and the route guide system 110. The vehicle 50 is provided with a navigation interface (I/F) unit 51, a driving I/F unit 52, a positioning sensor 53, a vehicle electronic control unit (ECU) 54, a vehicle control system 55, and an external camera 56. The navigation I/F unit 51 is a user interface for performing a route guide and includes a touch panel display, various switches, a speaker, and so on. The driving I/F unit 52 is a device for executing operation related to driving (including also automatic driving) and for outputting data related to the driving. The driving I/F unit 52 includes various operation members such as a steering wheel, a pedal, and a lever, and various data output units.

The vehicle ECU 54 is a computer for controlling the vehicle control system 55. In manual driving, the vehicle ECU 54 controls the vehicle control system 55 in accordance with operation on the driving I/F unit 52. In automatic driving, the vehicle ECU 54 controls the vehicle control system 55, based on a command from the driving control system 10. The vehicle control system 55 includes various actuators for accelerating, decelerating, and steering the vehicle 50.

The positioning sensor 53 is a sensor for specifying a current position of the vehicle 50, and examples thereof may include a global positioning system (GPS) receiver, a vehicle speed sensor, and a gyro sensor. The route guide system 110 performs the route guide based on the current position of the vehicle 50. The external camera 56 is a camera which shoots front scenes and rear scenes of the vehicle 50 to obtain a high-precise current position of the vehicle 50 by image recognition processing on images of the front scenes and the rear scenes.

### (1-2) Configuration of Route Guide System:

The route guide system 110 searches a traveling plan route of the vehicle 50 and guides the vehicle 50, based on map data MD2 for route guide. For that, the route guide system 110 includes a controller 120, a storage medium 130, and a communication unit 140. The controller 120 is provided with a central processing unit (CPU), a random access memory (RAM), a read only memory (ROM), and the like to execute a route guide program 121 which is stored in the storage medium 130 or the ROM. The communication unit 140 communicates with the driving control system 10 which specifies a traveling road for control on which the vehicle is traveling, and which performs driving control based on the traveling road for control. The communication unit 140 is a wired communication circuit that makes the route guide system 110 communicate with the various units 51 to 56 of the vehicle 50 and the driving control system 10. Naturally, the communication unit 140 may be a wireless communication circuit.

The storage medium 130 records the map data MD2 for route guide and traveling plan route data GR therein. The map data MD2 for route guide includes node data, link data, and guide data. The node data mainly shows data regarding intersections (which include forks and junctions of the roads). Concretely, the node data shows coordinates of nodes respectively corresponding to the intersections. The link data shows various kinds of data, such a link ID, a section length, a travel time, and a speed limit, regarding a link corresponding to a road section. The road section refers to a unit of the road which is divided by continuous intersections in longitudinal direction. The nodes are respectively provided on both ends of the link. The node on which three or more links are connected to each other corresponds to the intersection.

The link ID is associated with the corresponding link to be inherent. The section length is a length of the road section. The link data contains shape interpolation point data. The shape interpolation point data is data indicating coordinates of shape interpolation points each of which is disposed on a center in a width direction of the road section. The guide data is data which stores sounds and images used for the route guide.

The traveling plan route data GR is data which shows the traveling plan route. The traveling plan route includes a series of the road sections which continually connect from a departure point to a destination point. The traveling plan route data GR is the data which shows each link ID of the series of the road sections constituting the traveling plan route.

The route guide program 121 includes a route guide module 121a. The route guide module 121a is a program module which makes the controller 120, as a computer, function as a route guide portion.

The controller 120 specifies a traveling link for guide, being the road section on which the vehicle is traveling, and performs the route guide based on the traveling link for guide, by a function of the route guide module 121a. The controller 120 obtains the departure point and the destination point in accordance with operation on the navigation I/F unit 51 and searches the traveling plan route which connects from the departure point to the destination point, by the function of the route guide module 121a.

The controller 120 calculates a search cost for each of the road section and searches the traveling plan route to minimize the sum of the search costs. For example, the search cost is calculated so that the larger the section length, the travel time, and the like become, the larger the search cost becomes. For example, the controller 120 executes a route search by a known method such as Dijkstra's algorithm. The controller 120 stores the traveling plan route data GR which shows the searched traveling plan route in the storage medium 130 and guides the traveling plan route based on the traveling plan route data GR, by the function of the route guide module 121a.

The controller 120 executes map matching with the road section indicated in the map data MD2 for route guide, by the function of the route guide module 121a, to specify a current position for guide which corresponds to the current position of the vehicle 50 on the road section. Specifically, the controller 120 forms a self-contained navigation trail based on output signals from the vehicle speed sensor and the gyro sensor as the positioning sensor 53 and corrects the self-contained navigation trail based on GPS positioning data which the GPS receiver has received. Further, the controller 120 specifies the traveling link for guide, being the road section whose degree of matching with a shape and a position of the self-contained navigation trail is highest, in the road sections which the map data MD2 for route guide shows. A shape of each of the road sections, which is specified by the map data MD2 for route guide, is specified based on the coordinates of the nodes and the shape interpolation points on the road sections. A method of the map matching is not particularly limited, and known various methods are applicable.

As described above, the route guide system 110 specifies the traveling link for guide as a traveling road for guide, based on the map data MD2 for route guide. Further, the controller 120 specifies the current position for guide of the vehicle 50 on the traveling link for guide, by the function of the route guide module 121a, and makes the navigation I/F unit 51 output images and sounds to perform guide of the traveling plan route in accordance with the current position for guide.

The controller 120 performs reroute by the function of the route guide module 121a when the current position for guide of the vehicle 50 is deviated from the traveling plan route. That is, the controller 120 performs the reroute because of deviation of the current position for guide of the vehicle 50 from the traveling plan route when a road section which is different from the road section on the traveling plan route is specified as the traveling link for guide. Concretely, the controller 120 cancels the route guide with an existing traveling plan route and discards the traveling plan route data GR indicating the traveling plan route. Further, the controller 120 searches the traveling plan route to the former destination point with the current position for guide which is deviated from the existing traveling plan route, as a new departure point. The controller 120 stores the traveling plan route data GR indicating a traveling plan route searched by the reroute in the storage medium 130 and guides the traveling plan route as a new traveling plan route.

The controller 120 also performs the reroute by the function of the route guide module 121a when receiving a reroute request from the driving control system 10. Specifically, the controller 120 cancels the route guide with the existing traveling plan route and discards the traveling plan route data GR indicating the traveling plan route. Further, the controller 120 searches the traveling plan route to the former destination point with a current position for control, which is specified by the reroute request, as a new departure point. The controller 120 stores the traveling plan route data GR indicating a traveling plan route searched by the reroute in the storage medium 130 and guides the traveling plan route as a new traveling plan route. Incidentally, the current position for control is the current position of the vehicle 50 which is specified by the driving control system 10, and is also the position which is specified by the reroute request.

The controller 120 outputs the traveling plan route to the driving control system 10 by the function of the route guide module 121a. Concretely, the controller 120 stores the traveling plan route data GR in the storage medium 130 and outputs the traveling plan route data GR to the driving control system 10 every time the traveling plan route is searched. That is, the controller 120 outputs the traveling plan route data GR to the driving control system 10 every time the traveling plan route is searched. Naturally, in cases where the reroute is performed, the controller 120 outputs the traveling plan route data GR to the driving control system 10 every time the traveling plan route is searched. Therefore, the traveling plan route data GR indicating the traveling plan route after the reroute is outputted to the driving control system 10.

### (1-3) Configuration of Driving Control System:

The driving control system 10 prepares a driving control plan DP of the vehicle on the traveling plan route, based on map data MD1 for driving control. For that, the driving control system 10 includes the controller 20, a storage medium 30, and a communication unit 40. The communication unit 40 communicates with the route guide system 110 which specifies the traveling link for guide, being the road section on which the vehicle 50 is traveling, and performs the route guide based on the traveling link for guide. The communication unit 40 is a wired communication circuit that makes the driving control system 10 communicate with the various units 51 to 56 of the vehicle 50 and the route guide system 110. Naturally, the communication unit 40 may be a wireless communication circuit. The controller 20 is provided with a CPU, a RAM, a ROM, and the like so as to execute a driving control program 21 which is stored in the storage medium 30 or the ROM. A configuration including the driving control program 21 and the route guide program 121 corresponds to a driving support program of the present invention.

The storage medium 30 records the map data MD1 for driving control, the traveling plan route data GR, and the driving control plan DP therein. The map data MD1 for driving control is map data in which, for example, shapes of each intersection and each road section are indicated in more detail than the map data MD2 for route guide. Specifically, the map data MD1 for driving control contains lane structure data, lane shape data, surface paint data, and the like in addition to the shape interpolation point data which is the same as that of the map data MD2 for route guide. The lane structure data is data indicating the number of lanes and status of additional lanes near the intersections with respect to each of the road sections. The lane shape data is data indicating a width of each of the lanes and a length of each of the lanes, and so on. The surface paint data is data specifying a position and a content of a paint which indicates a traffic restriction on the road surface. In the map data MD1 for driving control and the map data MD2 for route guide, the same link ID is associated with each of the same road sections. The driving control plan DP shows target positions which are represented by a time series and which are provided on the traveling plan route, target vehicle speed at each of the target positions, target acceleration and deceleration at each of the target positions, and target steering angle at each of the target positions.

The traveling plan route data GR is data specifying the traveling plan route. After receiving the traveling plan route data GR from the route guide system 110, the driving control system 10 records the traveling plan route data GR in the storage medium 30 as the traveling plan route data GR without modification.

The driving control program 21 contains a driving control module 21a and a cancel control module 21b. The driving control module 21a and the cancel control module 21b are program modules each of which makes the controller 20, as a computer, function as a driving control portion and a cancel control portion.

The controller 20 specifies a traveling link for control, being the road section on which the vehicle 50 is traveling, and performs the driving control based on the traveling link for control, by a function of the driving control module 21a. Concretely, the controller 20 obtains the images of the front scenes and the rear scenes of the vehicle 50 which are shot by the external camera 56, and performs the image recognition processing on the images to specify the traveling link for control, being a traveling section on which the vehicle 50 is traveling. For example, the controller 20 obtains the self-contained navigation trail just like the route guide system 110. Further, the controller 20 specifies candidate links, being a indicated number of road sections whose degree of matching with the position and the shape of the self-contained navigation trail are not smaller than a predetermined threshold, in the road sections which the map data MD2 for route guide shows.

Further, the controller 20 recognizes images of lane comparting lines and road surface marking paints by performing the image recognition processing on the images which are shot by the external camera 56. The lane comparting line is a white line or a yellow line which comparts the lane. The controller 20 compares the lane structure data, the lane shape data, and the surface paint data concerning each of the candidate links with positions of the images obtained by the image recognition processing, so that the candidate link where the vehicle 50 is most likely to be running is specified as the traveling link for control.

As described above, the controller 20 of the driving control system 10 specifies the traveling link for control, by the driving control module 21a, based on the map data MD1 for driving control which is more high-precise than the map data MD2 for route guide. The controller 20 compares the lane structure data, the lane shape data, and the surface paint data concerning the traveling link for control with the positions of the images obtained by the image recognition processing to specify a current position for control, being a current position of the vehicle 50 on the traveling link for control, by the lanes.

Further, the controller 20 performs the driving control by the function of the driving control module 21a to travel on the traveling plan route which is searched and guided by the route guide system 110. That is, the controller 20 obtains the lane structure data and the lane shape data which correspond to the link ID of the road section on the traveling plan route specified by the traveling plan route data GR which is stored in the storage medium 30, by the function of the driving control module 21a. The controller 20 sets of a time series of the target positions for traveling the vehicle 50 on the road section, based on the lane structure data and the lane shape data. The controller 20 sets the target vehicle speed at each of the target positions, the target acceleration and deceleration at each of the target positions, and the target steering angle at each of the target positions. The controller 20 prepares the driving control plan DP specifying the target positions which are represented by a time series, the target vehicle speed at each of the time series of the target positions, the target acceleration and deceleration at each of the target positions, and the target steering angle at each of the target positions.

The controller 20 feedback-controls the vehicle control system 55 by the function of the driving control module 21a so as to realize the target vehicle speed at each of the target positions, the target acceleration and deceleration at each of the target positions, and the target steering angle at each of the target positions, specified by the driving control plan DP. Specifically, the controller 20 feedback-controls the vehicle control system 55 so that the current position for control gets closer to the target position specified by the driving control plan DP. Similarly, the controller 20 feedback-controls the vehicle control system 55 so that real acceleration and deceleration, and real steering angle get closer to the target acceleration and deceleration, and the target steering angle specified by the driving control plan DP respectively. The controller 20 realizes the automatic driving by outputting control data specifying control amount of the feedback-control in the vehicle control system 55 to the vehicle ECU 54.

The controller 20 cancels at least one of the route guide and the driving control by a function of the cancel control module 21b when the traveling link for guide as the traveling road for guide and the traveling link for control as the traveling road for control are not consistent with each other. Concretely, the controller 20 cancels the route guide and continues the driving control, by the function of the cancel control module 21b, when the traveling link for guide and the traveling link for control are not consistent with each other. More specifically, the controller 20 cancels the route guide and continues the driving control, by the function of the cancel control module 21b, when the traveling link for control is not the road on the traveling plan route in a state where the controller 20 does not receive the traveling plan route after the reroute from the route guide system 110.

As described above, the route guide system 110 performs the reroute when the traveling link for guide is not the road section on the traveling plan route. The route guide system 110 outputs, to the driving control system 10, the traveling plan route data GR specifying the traveling plan route after the reroute which is searched by the reroute. Therefore, a state where the driving control system 10 does not receive the traveling plan route data GR specifying the traveling plan route after the reroute means that the route guide system 110 specifies the road section on the traveling plan route as the traveling link for guide. Namely, in cases where the route guide system 110 specifies the road section on the traveling plan route as the traveling link for guide, the route guide system 110 does not detect route deviation and does not input the traveling plan route after the reroute. In this situation, in cases where the traveling link for control which is specified by the driving control system 10 is not the road section on the traveling plan route, it is decided that the traveling link for guide (on the traveling plan route) and the traveling link for control (not on the traveling plan route) are not consistent with each other. In this situation, the controller 20 cancels the route guide and continues the driving control, by the function of the cancel control module 21b.

The controller 20 cancels the route guide and makes the route guide system 110 search a route from the traveling link for control to the destination point as the traveling plan route after the reroute, by the function of the cancel control module 21b, when the traveling link for control is not the road section on the traveling plan route in a state where the controller 20 does not receive the traveling plan route after the reroute from the route guide system. Concretely, the controller 20 outputs the reroute request to the route guide system 110 by the function of the cancel control module 21b. The reroute request is data specifying the current position for control which is specified on the traveling link for control. The reroute request is the data requesting that the reroute is performed with the current position for control as the departure point. The route guide system 110 which receives the reroute request cancels the guide of the existing traveling plan route and performs the reroute with the current position for control specified by the reroute request as the departure point.

The controller 20 outputs the reroute request to the route guide system 110 and continues the driving control, by the function of the cancel control module 21b. Specifically, the controller 20 performs the driving control to cause the vehicle 50 to travel along the road on the traveling link for control, by the function of the cancel control module 21b. The controller 20 thus continues the driving control. The controller 20 prepares a new driving control plan DP in order to perform the driving control so that the vehicle travels along the road from the traveling link for control, and performs the automatic driving based on the driving control plan DP. For example, the controller 20 obtains a route leaving in order from the traveling link for control as a starting point to a road section to minimize changes in direction of the travel on the intersection, and a route which is composed of the road sections disposed on the same line as the traveling link for control as a provisional travel plan route. The controller 20 provisionally prepares the new driving control plan DP in which the target positions which are represented by a time series are set on the travel plan route.

According to the embodiment described above, when the traveling link for guide that is specified by the route guide system 110 and the traveling link for control that is specified by the driving control system 10 are not consistent with each other, a possibility that the route guide and the driving control are respectively performed on the roads that are not consistent with each other is reduced by cancelling the route guide.

The driving control system 10 specifies the traveling link for control based on the map data MD1 for driving control which is more high-precise than the map data MD2 for route guide used for specifying the traveling link for guide by the route guide system 110. In this configuration, the traveling link for control which is specified based on the high-precise map data MD1 for driving control is likely to be more reliable than the traveling link for guide. Therefore, while the route guide based on the traveling link for guide which is not so reliable is canceled, the driving control based on the traveling link for control which is reliable is continued.

Since the route guide system 110 searches the route from the traveling link for control to the destination point as the traveling plan route after the reroute when the traveling link for guide and the traveling link for control are not consistent with each other, the route from the reliable traveling link for control which is reliable to the destination point is searched as the traveling plan route after the reroute.

### (2) Driving Control Processing

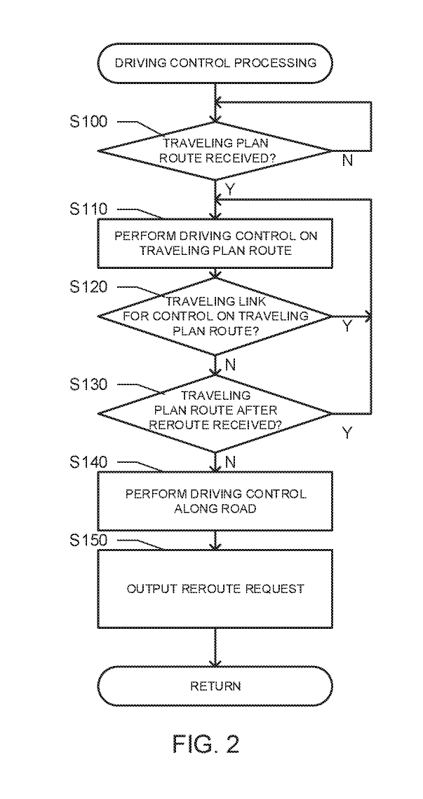

Driving control processing which is performed by the driving control system 10 will be described. FIG. 2 is a flowchart showing the driving control processing. First, the controller 20 determines whether the traveling plan route is inputted, by the function of the driving control module 21a (step S100). Namely, the controller 20 determines whether or not the traveling plan route data GR is inputted from the route guide system 110. When it is not determined that the traveling plan route is inputted (step S100: N), the driving control processing by the controller 20 returns to step S100 in which the controller 20 waits for input of the traveling plan route.

On the contrary, when it is determined that the traveling plan route is inputted (step S100: Y), the controller 20 performs the driving control to cause the vehicle 50 to travel on the traveling plan route, by the function of the driving control module 21a (step S110). That is, the controller 20 records the traveling plan route data GR in the storage medium 30, prepares the driving control plan DP to travel on the traveling plan route specified by the traveling plan route data GR, and controls the vehicle control system 55 based on the driving control plan DP. At this time, the route guide as to the traveling plan route specified by the traveling plan route data GR is performed in the route guide system 110.

The controller 20 determines whether or not the traveling link for control is positioned on the traveling plan route, by the function of the cancel control module 21b (step S120). Namely, the controller 20 determines whether or not the traveling link for control which is specified based on the high-precise map data MD1 for driving control is the road section which is positioned on the existing traveling plan route specified by the traveling plan route data GR. When it is determined that the traveling link for control is positioned on the traveling plan route (step S120: Y), the driving control processing by the controller 20 returns to step S110. That is, the controller 20 continues the driving control to cause the vehicle 50 to travel on the travel plan route, because the vehicle 50 is traveling on the travel plan route according to the plan.

When it is not determined that the traveling link for control is positioned on the traveling plan route (step S120: N), the controller 20 determines whether or not the traveling plan route after the reroute is inputted (step S130), by the function of the cancel control module 21b. Namely, the controller 20 determines whether or not the route guide system 110 detects itself that the traveling link for guide is not the road section which is positioned on the traveling plan route (the traveling link for guide is deviated from the traveling plan route) and performs the reroute.

When it is determined that the traveling plan route after the reroute is inputted (step S130: Y), the driving control processing by the controller 20 returns to step S110. Namely, the controller 20 performs the driving control to cause the vehicle 50 to travel on the traveling plan route after the reroute. The return of the driving control processing from step S130 to step S110 means that both the driving control system 10 and the route guide system 110 detect deviation from the traveling plan route. In this case, the route guide and the driving control are performed with respect to the traveling plan route after the reroute which is executed from the traveling link for guide specified by the route guide system 110 as the departure point.

When it is not determined that the traveling plan route after the reroute is inputted (step S130: N), the controller 20 performs the driving control along the road by the function of the cancel control module 21b (step S140). Namely, the controller 20 obtains a provisional traveling plan route permitting the vehicle 50 to travel along the road from the traveling link for control, and provisionally prepares the new driving control plan DP in which the target positions which are represented by a time series are set on the travel plan route. The controller 20 executes the driving control based on the provisional driving control plan DP. Consequently, the automatic driving is continued.

Then, the controller 20 outputs the reroute request which sets the traveling link for control (current position for control) as the departure point to the route guide system 110, by the function of the cancel control module 21b (step S150). The reroute request is data specifying the current position for control which is specified on the traveling link for control. The reroute request is the data requesting that the reroute is performed with the current position for control as the departure point. On one hand, the route guide system 110 which receives the reroute request cancels the guide of the existing traveling plan route and performs the reroute with the current position for control specified by the reroute request as the departure point. When the reroute request is outputted, the driving control processing by the controller 20 of the driving control system 10 returns to step S100 (RETURN). That is, the controller 20 waits for input of the traveling plan route after the reroute which is performed in accordance with the reroute request.

### (3) Second Embodiment

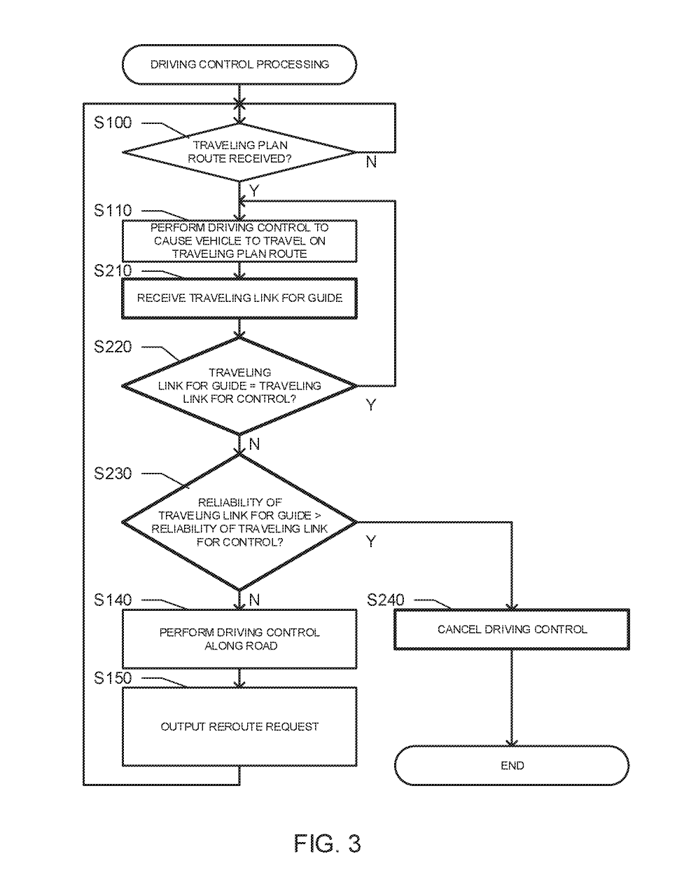

FIG. 3 is a flowchart showing driving control processing according to a second embodiment. In the driving control processing according to the second embodiment, steps S210, S220, S230, and S240 which are different from the steps of the driving control processing according to the first embodiment (FIG. 2) are specified by thick frames. Steps S210, S220, S230, and S240 different from the steps of the driving control processing according to the first embodiment will be described hereinafter.

When the driving control is started in step S110, the controller 20 receives the traveling link for guide from the route guide system 110 by the function of the cancel control module 21b (step S210). For example, the controller 20 may issue, to the route guide system 110, a request to transmit the traveling link for guide whenever the vehicle 50 passes through the intersection. After that, the controller 20 determines whether or not the traveling link for guide and the traveling link for control are consistent with each other, by the function of the cancel control module 21b (step S220). Namely, the controller 20 determines whether or not the traveling link for guide specified by the route guide system 110 and the traveling link for control specified by the driving control system 10 are consistent with each other.

When it is determined that the traveling link for guide and the traveling link for control are consistent with each other (step S220: Y), the driving control processing by the controller 20 returns to step S110. That is, the controller 20 continues the driving control to cause the vehicle 50 to travel on the travel plan route, because the vehicle 50 is traveling on the travel plan route as planned.

On the contrary, when it is not determined that the traveling link for guide and the traveling link for control are consistent with each other (step S220: N), the controller 20 determines whether or not the traveling link for guide is more reliable than the traveling link for control, by the function of the cancel control module 21b (step S230). Reliability of the traveling link for guide corresponds to reliability of the map matching. For example, the higher degree of similarity between the self-contained navigation trail and position and shape of the traveling link for guide becomes, the higher the reliability of the traveling link for guide may become. Further, the more the neighboring road sections each having the position and the shape which are similar to those of the traveling link for guide becomes, the less the reliability of the traveling link for guide may become. The reliability of the traveling link for control may be calculated based on, for example, conditions of the image recognition processing on the images shot by the external camera 56. The higher the edge amount (sharpness) in the image recognition processing becomes, the higher the reliability of the traveling link for control may become. Further, the higher degree of shielding by an obstacle such as the lane comparting line becomes, the less the reliability of the traveling link for control may become.

When it is determined that the traveling link for guide is more reliable than the traveling link for control (step S230: Y), the controller 20 cancels the driving control by the function of the cancel control module 21b (step S240). That is, when the traveling link for guide and the traveling link for control are not consistent with each other and the traveling link for guide is more reliable than the traveling link for control, the controller 20 cancels the driving control by the function of the cancel control module 21b. Specifically, while the controller 20 informs a driver of a change into manual driving, the controller 20 changes from the automatic driving into the manual driving.

On the contrary, when it is not determined that the traveling link for guide is more reliable than the traveling link for control (step S230: N), the controller 20 performs the driving control along the road (step S140) and outputs the reroute request with the traveling link for control (the current position for control) as the departure point to the route guide system 110, by the function of the cancel control module 21b (step S150). Namely, when the traveling link for guide and the traveling link for control are not consistent with each other and the reliability of the traveling link for guide is equal to or less than that of the traveling link for control, the controller 20 cancels the route guide by the function of the cancel control module 21b. As described above, in the configuration in which the reliability of the traveling link for guide and the reliability of the traveling link for control are comparable with each other, one of the driving control and the route guide executed with respect to the traveling road which is less reliable is cancelled.

### (4) Other Embodiments

As illustrated in FIG. 1 by a broken line, when the traveling link for guide and the traveling link for control are not consistent with each other, the controller 120 of the route guide system 110 may execute a cancel control module 121b which cancels at least one of the route guide and the driving control. Namely, the route guide system 110 may determine whether or not the traveling link for guide and the traveling link for control are consistent with each other. In this case, the controller 120 of the route guide system 110 may inquire the traveling link for control of the driving control system 10. Also in this configuration, when the traveling link for guide that is specified by the route guide system 110 and the traveling link for control that is specified by the driving control system 10 are not consistent with each other, the possibility that the route guide and the driving control are respectively performed on the roads that are not consistent with each other is reduced by cancelling at least one of the route guide and the driving control.

The traveling link for guide and the traveling link for control are not necessarily specified based on map data with different precision, respectively. Further, the reliability of the traveling link for guide and the reliability of the traveling link for control may not be compared with each other. When the traveling link for guide and the traveling link for control are not consistent with each other, the controller 20 may cancel both the route guide and the driving control regardless of the reliability. Furthermore, when the traveling link for guide and the traveling link for control are not consistent with each other, the controller 20 does not necessarily have to output the reroute request to the route guide system 110. The controller 20 may simply cancel the route guide.

In a configuration in which the traveling link for control is likely to be more reliable as the first embodiment, when the traveling link for guide is not the road section which is positioned on the traveling plan route and the traveling link for control is the road section which is positioned on the traveling plan route, the controller 20 may continue the driving control to cause the vehicle 50 to travel on the existing traveling plan route, and may issue a command to the route guide system 110 so that the route guide system 110 continues the route guide with the existing traveling plan route.

In the present invention, as long as the driving control system and the route guide system communicate with each other, a communication means may be wired communication or wireless communication. Further, the route guide system may include a plurality of devices which communicate with each other so that a server may perform the route search and a device equipped on the vehicle may guide the route. The traveling plan route is the route on which the controlled vehicle will travel. The traveling plan route is the route connecting from the departure point to the destination point so that, for example, the traveling plan route may be specified with a series of the road sections (links) connecting from the departure point to the destination point. The driving control is to perform the automatic driving and the automatic driving may be to automatically control acceleration and deceleration and may be to automatically control steering.

The driving control system may communicate with the route guide system by the wired communication or the wireless communication. Specifying method for specifying the traveling road for guide and specifying method for specifying the traveling road for control may be different from each other. Data used for specifying the traveling road for guide and data used for specifying the traveling road for control (the map data, measurement data of sensor, and the like) may be different from each other, and an algorithm used for specifying the traveling road for guide and an algorithm used for specifying the traveling road for control may be different from each other.

The cancel control portion may cancel at least one of the route guide and the driving control. Therefore, the cancel control portion may cancel one of the route guide and the driving control or the cancel control portion may cancel both the route guide and the driving control. To cancel may be to terminate the route guide or the driving control, may be to suspend the route guide or the driving control temporarily, or may be to inform of a probability that the route guide or the driving control is not properly performed.

Specifically, the route guide portion may specify the traveling road for guide based on the map data for route guide and the driving control portion of the driving control system may specify the traveling road for control based on the map data for driving control which is more high-precise than the map data for route guide. The cancel control portion may cancel the route guide and continue the driving control when the traveling road for guide and the traveling road for control are not consistent with each other. In this configuration, the traveling road for control which is specified by using the high-precise map data for driving control is likely to be more reliable than the traveling road for guide. Therefore, while the route guide based on the traveling road for guide which is not so reliable is canceled, the driving control based on the traveling road for control which is reliable is continued.

Further, the driving control portion may perform the driving control to cause the vehicle to travel on the traveling plan route searched and guided by the route guide portion, and the cancel control portion may cancel the route guide and continue the driving control when the traveling road for control is not the road on the traveling plan route in a state where the driving control portion does not receive the traveling plan route after the reroute from the route guide portion. Incidentally, in cases where the route guide portion specifies the road on the traveling plan route as the traveling road for guide, the route guide portion does not detect the route deviation and does not input the traveling plan route after the reroute. In this situation, in cases where the traveling road for control is not the road on the traveling plan route, it is determined that the traveling road for guide (on the traveling plan route) and the traveling road for control (not on the traveling plan route) are not consistent with each other.

The cancel control portion may cancel the route guide and make the route guide portion search a route from the traveling road for control to the destination point as the traveling plan route after the reroute when the traveling road for control is not the road on the traveling plan route in a state where the traveling plan route after the reroute is not inputted into from the route guide portion. The traveling road for control which is specified by using the high-precise map data for driving control is likely to be more reliable than the traveling road for guide. Hence, a route from the reliable traveling road for control to the destination point is specified as the traveling plan route after the reroute.

Further, when the traveling road for guide and the traveling road for control are not consistent with each other and the traveling road for guide is more reliable than the traveling road for control, the cancel control portion may cancel the driving control. On the contrary, when the traveling road for guide and the traveling road for control are not consistent with each other and the reliability of the traveling road for guide is equal to or less than that of the traveling road for control, the cancel control portion may cancel the route guide. That is, in the configuration in which the reliability of the traveling road for guide and the reliability of the traveling road for control are comparable with each other, the driving control or the route guide executed with respect to the traveling road which is less reliable is cancelled.

Furthermore, in the present invention, a determination means which determines whether or not the traveling roads are consistent with each other between the route guide system and the driving control system may be applied as a program or a method. Further, the system, the program, and the method described above may be realized as a single device and may be realized in cooperation with a shared part with various portions equipped on the vehicle to include various aspects. For example, a navigation system, the driving control system and method, and a program each of which includes the device described above are provided. Further, according to the present invention, one portion of the configuration may be software and another portion may be hardware to be appropriately altered. Furthermore, the present invention is established as a storage medium of a program which controls the device. Needless to say, the storage medium of the software may be a magnetic storage medium and may be an optical storage medium, and may be deemed to include any storage medium to be developed in the future in entirely the same way.

What is claimed is:

1. A driving support system comprising:
a route guide portion configured to specify a traveling road for guide that is a road on which a vehicle is traveling and to perform a route guide based on the traveling road for guide;
a driving control portion configured to specify a traveling road for control that is the road on which the vehicle is traveling and to perform driving control based on the traveling road for control; and
a cancel control portion configured to cancel at least one of the route guide and the driving control when the traveling road for guide and the traveling road for control are not consistent with each other.

2. The driving support system according to claim 1, wherein
the route guide portion is configured to specify the traveling road for guide, based on map data for route guide,
the driving control portion is configured to specify the traveling road for control, based on map data for driving control that is more high-precise than the map data for route guide, and
the cancel control portion is configured to cancel the route guide and to continue the driving control when the traveling road for guide and the traveling road for control are not consistent with each other.

3. The driving support system according to claim 2, wherein
the driving control portion is configured to perform the driving control to cause the vehicle to travel on a traveling plan route that is searched and guided by the route guide portion, and
the cancel control portion is configured to cancel the route guide and continue the driving control when the traveling road for control is not a road on the traveling plan route in a state where the cancel control portion does not receive the traveling plan route after reroute from the route guide portion.

4. The driving support system according to claim 3, wherein
the cancel control portion is configured to cancel the route guide and to make the route guide portion search a route from the traveling road for control to a destination point as the traveling plan route after the reroute when the traveling road for control is not the road on the traveling plan route in the state where the cancel control portion does not receive the traveling plan route after the reroute from the route guide portion.

5. The driving support system according to claim 1, wherein
the cancel control portion is configured to cancel the driving control when the traveling road for guide and the traveling road for control are not consistent with each other and the traveling road for guide is more reliable than the traveling road for control, and
the cancel control portion is configured to cancel the route guide when the traveling road for guide and the traveling road for control are not consistent with each other and reliability of the traveling road for guide is equal to or less than reliability of the traveling road for control.

6. A driving control system for communicating with a route guide system configured to specify a traveling road for guide that is a road on which a vehicle is traveling and to perform a route guide based on the traveling road for guide,
the driving control system comprising:
a driving control portion configured to specify a traveling road for control that is the road on which the vehicle is traveling and to perform driving control based on the traveling road for control; and
a cancel control portion configured to cancel at least one of the route guide and the driving control when the traveling road for guide and the traveling road for control are not consistent with each other.

7. A route guide system for communicating with a driving control system configured to specify a traveling road for control that is a road on which a vehicle is traveling and to perform driving control based on the traveling road for control,
the route guide system comprising:
a route guide portion configured to specify a traveling road for guide that is the road on which the vehicle is traveling and to perform a route guide based on the traveling road for guide; and
a cancel control portion configured to cancel at least one of the route guide and the driving control when the traveling road for guide and the traveling road for control are not consistent with each other.

8. A non-transitory computer readable storage medium storing a driving support program that, when executed by a computer, causes the computer to function as:
a route guide portion configured to specify a traveling road for guide that is a road on which a vehicle is traveling and to perform a route guide based on the traveling road for guide;
a driving control portion configured to specify a traveling road for control that is the road on which the vehicle is traveling and to perform driving control based on the traveling road for control; and
a cancel control portion configured to cancel at least one of the route guide and the driving control when the traveling road for guide and the traveling road for control are not consistent with each other.
